(19) United States
(12) Patent Application Publication
(10) Pub. No.: US 2005/0198058 A1
(43) Pub. Date: Sep. 8, 2005

(54) Services offering delivery method

(75) Inventor: Barbara J. Dempsey, Kingwood, TX (US)

Correspondence Address: John R. Pivnichny;IBM Corporation, IP Law Dept. IQ0A, Bldg. 40-3, 1701 North Street, Endicott, NY, 13760, US

(73) Assignee: INTERNATIONAL BUSINESS MACHINES CORPORATION, ARMONK, NY (US)

(21) Appl. No.: 10/793,204

(22) Filed: Mar. 4, 2004

(51) Int. Cl. G06F 17/00

(52) U.S. Cl. 707/102

(57) ABSTRACT

A software product having numerous configurable objects and views is implemented for a services client. Once a configuration is planned, the impacted views and objects are automatically determined and presented to the installer in spreadsheet form. The installer configures the application by modifying data in the spreadsheets in accordance with the planned configuration. Reports and documents of the configuration are created automatically.

### TECHNICAL FIELD

The invention pertains to implementing a software product for a client. More particularly the invention relates to a method of configuring views and objects in the software product for use by a client company or use on behalf of a client company.

### BACKGROUND OF THE INVENTION

The information technology (IT) services providing industry has grown dramatically in recent years. One driver behind this growth is the desire of companies to outsource non-core operations in order to focus efforts on their core competencies. Services providing companies can typically perform IT services more efficiently for a plurality of clients than the individual client can perform themselves using in-house employees. Such outsourcing therefore typically provides a cost reduction to the operating (outsourcing) company and also a substantial profit margin to the IT services providing company.

For example, a third party software product may be procured, configured to the needs of the client, and delivered for use by client employees. Or the software may be delivered to the IT providing company employees for use on behalf of the client company. Such deliveries may involve hosting the configured application or providing an on-demand billed service involving use of the configured application.

Regardless of the use, configuring software products for a particular client requirement remains a complex, lengthy process. Furthermore, maintenance and upgrading of the configuration is also a difficult time-consuming process.

Various methods of performing software configuration have been developed. Braun et al. in U.S. Pat. No. 6,636,961 describe a system and method for configuring personal data for an operating system and collection of applications to be installed on a personal computer. A configuration tool operating in an interactive mode displays a dialog of an existing configuration and allows the installer or user to modify it. Configuration data can also be imported from or exported to a configuration data file. An installer can therefore export from an old system and import into a new one when system hardware is being upgraded. Their configuration tool can also be used in a non-interactive mode. U.S. Pat. No. 6,636,961 is incorporated herein by reference in its entirety.

Nevertheless, despite the availability of configuration tools such as described by Braun, current methods for configuring software products, particularly large products remains a lengthy process involving considerable manual activity. Products having hundreds or thousands of configurable objects or views may take weeks or months of manual activity to configure, determine the impact on other objects and views, and document a specific configuration for a client.

### OBJECTS AND SUMMARY OF THE INVENTION

It is therefore a principal object of the present invention to provide a method of implementing a software product for a client having enhanced configuration and documentation capability.

It is another object to provide a method of delivering a services offering wherein enhanced software configuration capabilities are possible.

It is yet another object to provide a method of deploying, installing, accessing, or integrating process software to provide enhanced software application configuration capabilities.

It is a further object to provide a method of on demand sharing of such process software.

These and other objects are attained in accordance with one embodiment of the present invention wherein there is provided a method of implementing a software product for a client, comprising the steps of acquiring a software product having a plurality of views and objects, planning a configuration of the software product for a client, automatically determining which of the plurality of views and objects are impacted by the configuration, modifying the impacted views and objects in accordance with the planned configuration, automatically checking the modified views and objects, creating reports populated with data from the modified views and objects, for delivery to the client, and automatically documenting the planned configuration.

### BRIEF DESCRIPTION OF THE DRAWINGS

FIG. 1 depicts a data flow for configuration data in accordance with the present invention;

FIGS. 2 and 3 are flowcharts for navigating a repository;

FIG. 4 is an example list of responsibility groups;

FIG. 5 is a summary list of object statistics;

FIG. 6 depicts selecting a field to be changed;

FIG. 7 identifies related fields that need to be changed;

FIG. 8 lists all applets that reference the fields of FIG. 7;

FIG. 9 shows field details; and

FIG. 10 shows a design document in word processor format for a business component.

### BEST MODE FOR CARRYING OUR THE IVENTION

For a better understanding of the present invention together with other and further objects, advantages, and capabilities thereof, reference is made to the following disclosure and the appended claims in connection with the above-described drawings.

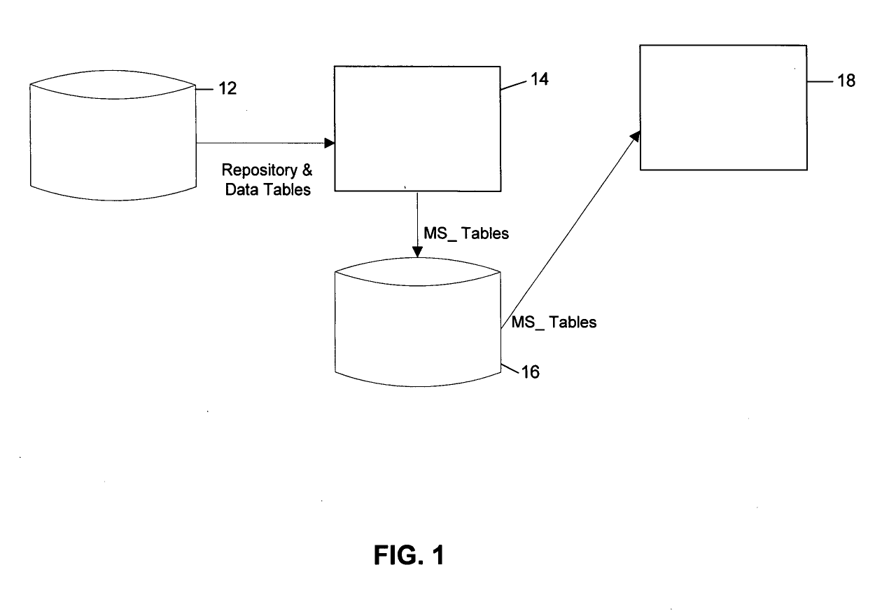

In FIG. 1 there is shown a dataflow diagram in accordance with the present invention. Software application 12 has a repository of objects and data. For a particular configuration of software application 12, first instruction code 14 selects a subset of the objects and data in application 12 and copies the selected objects and data into data tables 16. An impact analysis is performed to determine which of the plurality of views and data objects in application 12 are impacted by this configuration. These are copied into data tables 16. For example, all referenced objects are copied into data tables 16.

Second instruction code 18 is then run to produce spreadsheets listing the affected objects and views. These spreadsheets permit an installer to plan and document modifications to the impacted views and objects in data tables 16, in accordance with the planned configuration.

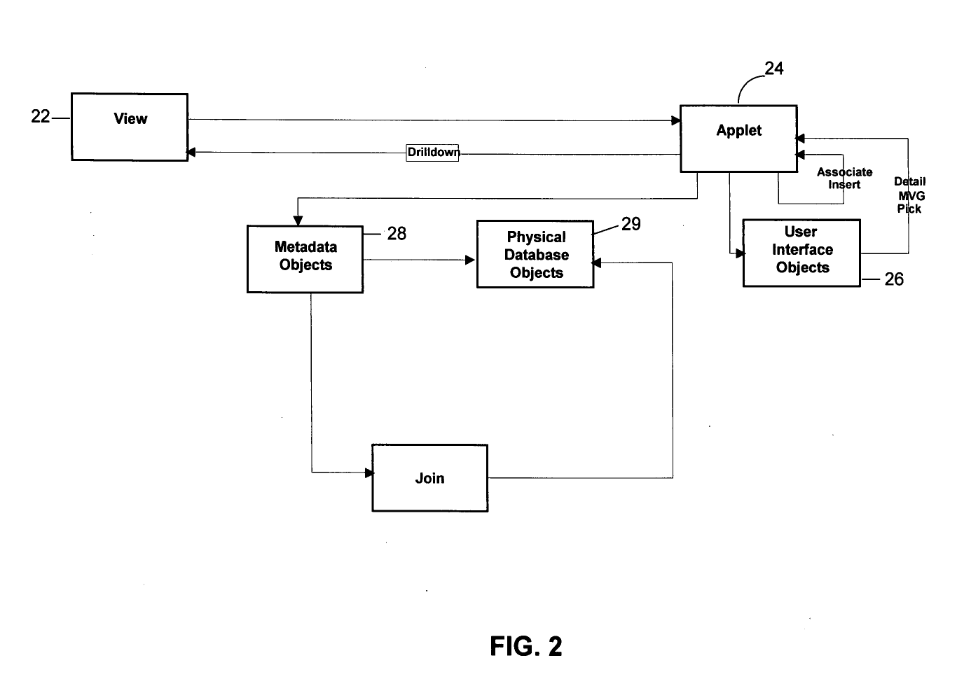

In FIG. 2 there is shown a flowchart for navigating software application 12 to determine which objects and views are used in the present configuration. These are the objects and views copied into data tables 16 above. Starting with a view 22, applets 24 are traversed to determine user interface objects 26. Metadata objects 28 are also determined and physical database objects are determined in step 29.

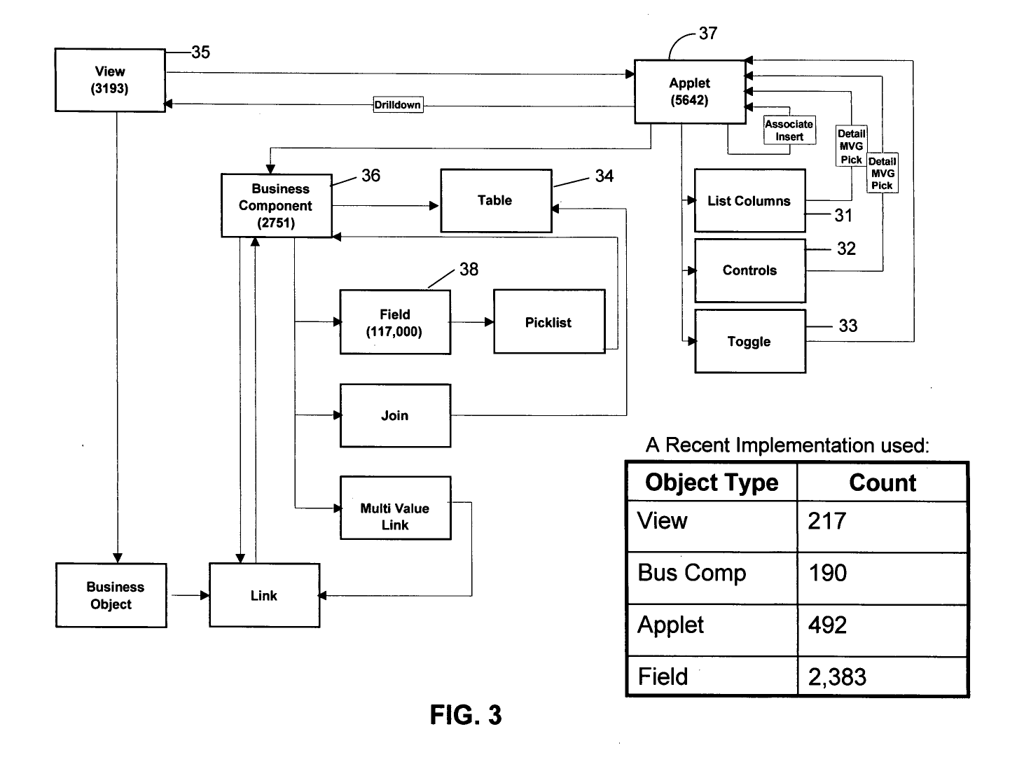

For a specific software application, such as a SIEBEL ER application (SIEBEL is a registered trademark of Siebel Systems, Inc. of San Mateo, Calif.), FIG. 3 depicts in more detail the steps used in navigating the repository in 12. For example, user interface objects comprise list columns 31, controls 32, and toggle 33. Physical database objects are determined in table 34.

All of the views 35 in a particular configuration are sequentially processed according to FIGS. 2 or 3. For example, as shown in FIG. 3, an implementation (configuration) used 217 views of the 3193 views 35 in the specific software application. From this navigation, 190 business components 36 of 2751, 492 applets 37 of 5642, and 2383 fields 38 of 117,000 were determined to be used in this configuration.

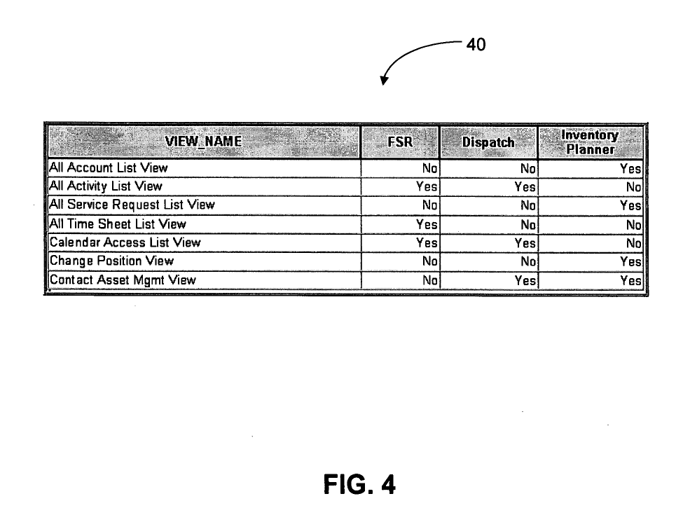

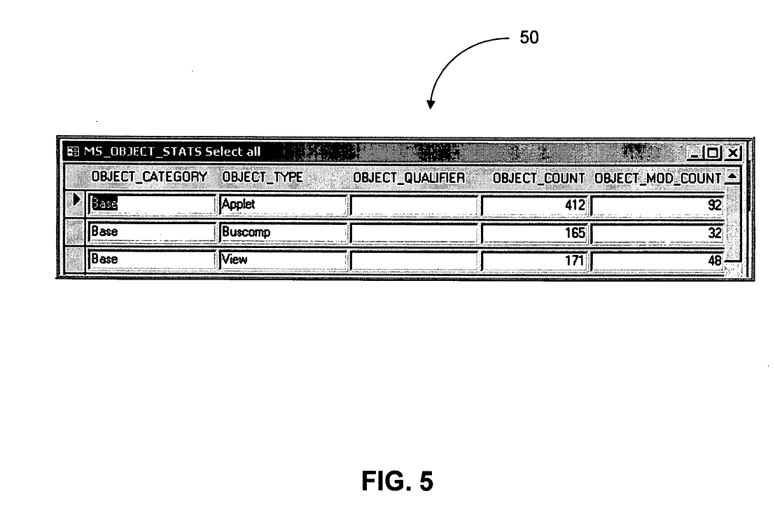

In FIG. 4 there is shown list 40 of all views associated with a responsibility group. As used herein a responsibility group shall be taken to mean a group of users having the same security access level. A user may select a responsibility group using second instruction code 18 and receive in response list 40. Instruction code 18 also provides statistics in table 50 of FIG. 5. For example, the number of applets used by the selected responsibility group or configuration is 412 objects.

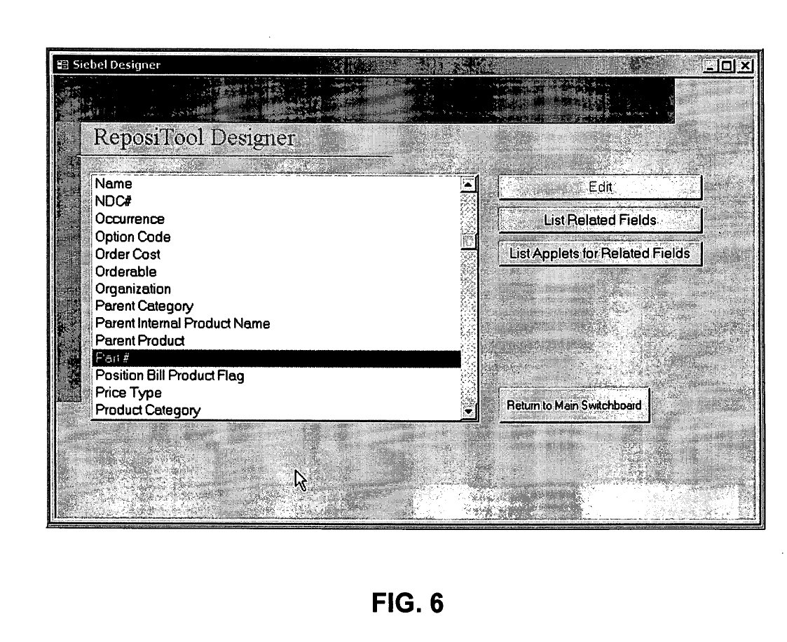

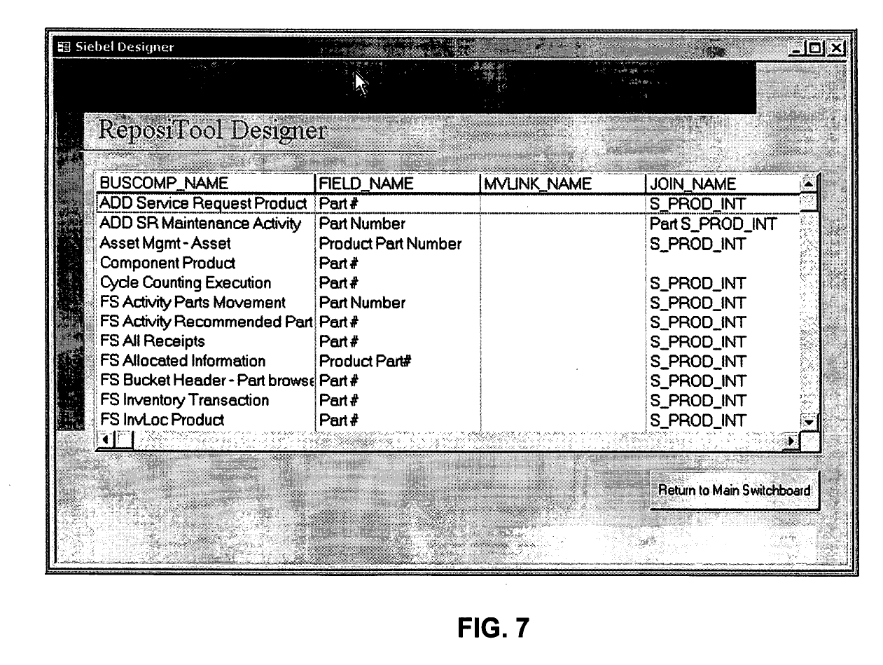

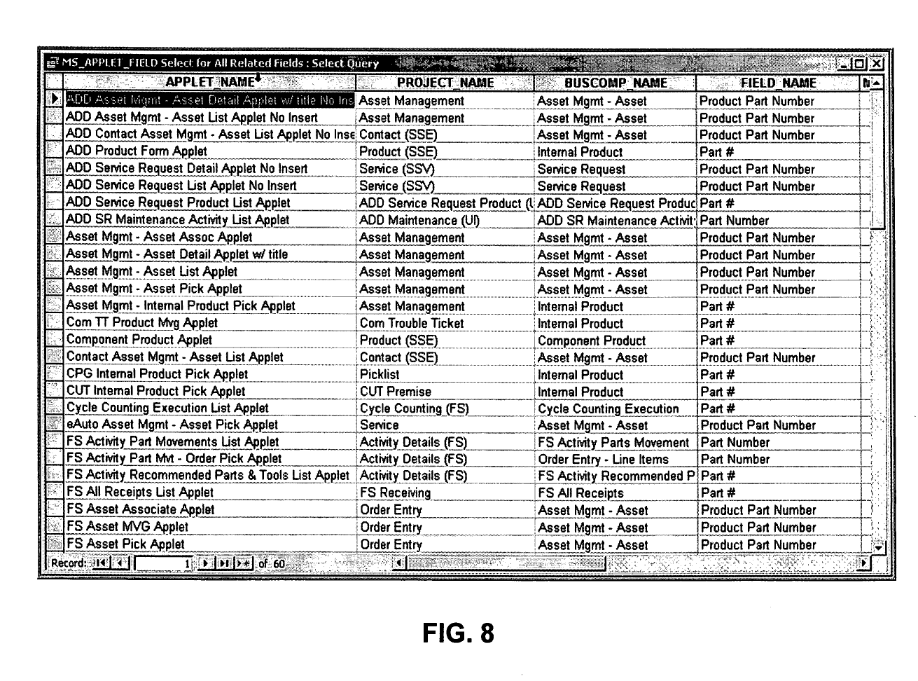

FIGS. 6-10 depict additional functions performed by second instruction code 18 which along with user manual tasks may be used to practice the present invention. In FIG. 6 a list of fields in the selected configuration is presented and the user selects a particular field (in this case the field is “Part #”). The user may need to modify the Part # field. Instruction code 18 determines and lists in FIG. 7 all other related fields in the selected configuration that need to be changed. Similarly all applets that reference these fields are determined and listed in FIG. 8.

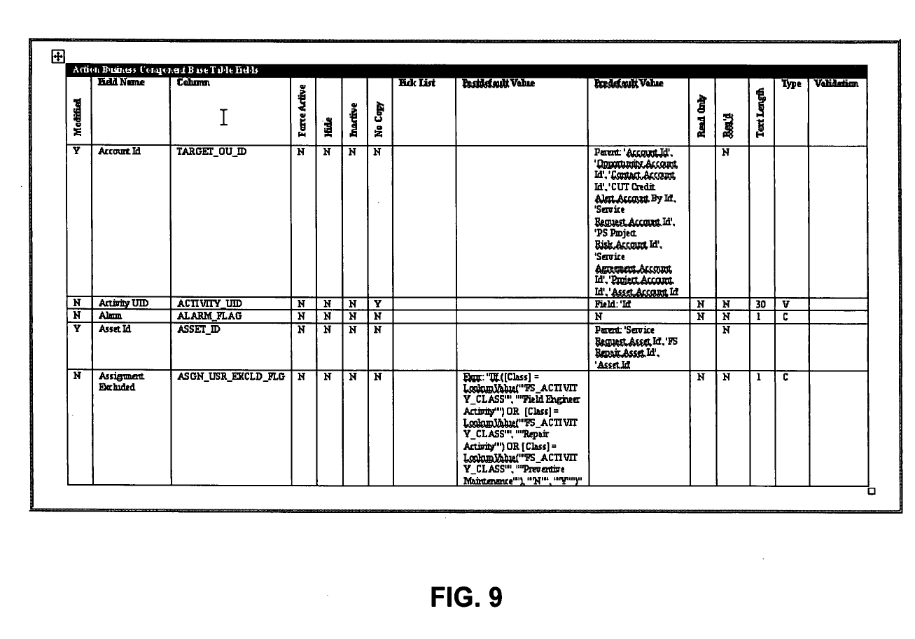

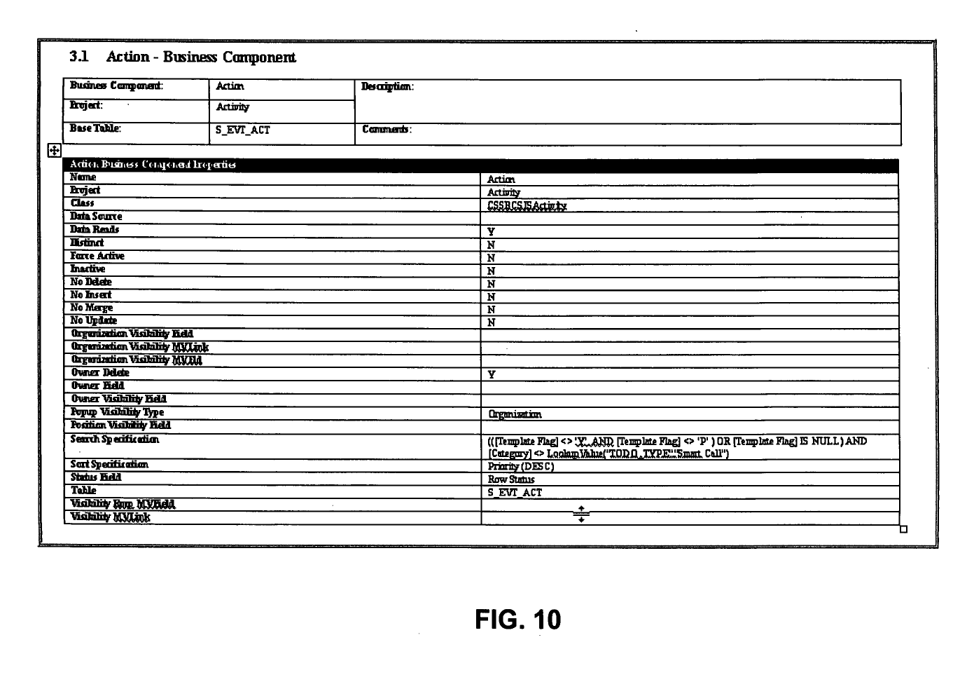

In FIG. 9 there is shown a report for a field and a related business component in FIG. 10. These are the elements which a user may wish to modify. The user may make such modifications employing an interface provided in the application. Having the lists provided in FIGS. 6-10 greatly minimizes the time needed to perform such a modification and determines which other fields must be modified. The field and business component data of FIGS. 9 and 10 may be presented to the user in spreadsheet or word processor format. Any other format may also be used, for example, to facilitate ease in reading, or compatibility with other formats as used by the software application.

Second instruction code 18 also generates a planning document for instructing the configurator on which modification to make.

The user may make modifications to the spreadsheets, word processor documents, or other formats and then cause second instruction code 18 to run reports for automatically documenting the modified configuration. The reports may be design documents including baseline design documents. These design documents may be in any known format including word processor format.

Those of ordinary skill in the art will appreciate that the user may also make modifications directly on the spreadsheets, word processor documents or other formats of FIGS. 9 and 10. Such modifications could then be transferred directly and automatically to the software application or indirectly through a user interface in the software application, thus further reducing the time required to modify a configuration.

The application or process software of the present invention may be performed on conventional stored-program computer architecture. Although it is understood that the process software for implementing a software product may be deployed by manually loading directly in client, server, and proxy computers via loading a storage medium such as a CD, DVD, and the like, the process software may also be automatically or semi-automatically deployed into a computer system by sending the process software to a central server or a group of central servers. The process software is then downloaded and executed by client computers. Alternatively, the process software is sent directly to the client system via email. The process software is then either detached to a directory or loaded into a directory by a button associated with the email that executes a program on demand. The executed program detaches the process software into a directory. Another alternative is to send the process software directly to a directory on the client computer hard drive. When there are proxy servers, the process software will select the proxy server code, determine which computers to place the proxy servers' code, transmit the proxy server code, and install the proxy server code on the proxy computer. The process software is then transmitted to the proxy server and stored therein.

In another embodiment, a transaction is sent to servers that contain the process software. The servers then process the transaction, and receive and copy the process software to the servers' file systems. Once the process software is stored at the servers, the users via their client computers access the process software on the servers and copy to their client computers file systems. In a separate embodiment, the servers automatically copy the process software to each client and then run the installation program for the process software at each client computer. The user executes the program that installs the process software on his client computer.

The process software for implementing a software product may be integrated into a client, server, and network environment providing for the process software to coexist with applications, operating systems, or network operating systems software, and installing the process software on the clients and servers in an environment where the process software will function.

Business importance of on demand computing is increasingly becoming a desired attribute. The process software of the present invention implementing a software product may be shared; simultaneously serving multiple customers in a flexible, automated fashion. It is standardized, requiring little customization, and is scalable, providing capacity on demand in a pay-as-you-go model.

The process software can be stored on a shared file system accessible from one or more servers. The process software is executed via transactions that contain data and server processing requests using CPU units on the accessed server. CPU units are units of time such as minutes, seconds, and hours on the central processor of the server. Additionally the assessed server may make requests of other servers that require CPU units. CPU units are an example that represents but one measurement of use. Other measurements of use include, but are not limited to, network bandwidth, memory usage, storage usage, packet transfers, and complete transactions.

When multiple customers use the same process software application, their transactions are differentiated by the parameters included in the transactions identifying a unique customer and the type of service for that customer. All of the CPU units and other measurements of use that are used for the services for each customer are recorded. When the number of transactions to any one server begins to affect the performance of that server, other servers are accessed to increase capacity and share the workload. Likewise when other measurements of use such as network bandwidth, memory usage, and storage usage, approach a capacity that affects performance, additional network bandwidth, memory usage, or storage, is added to share the workload.

The measurements of use for each service and customer are sent to a collecting server that sums the measurements of use for each customer. This is performed for each service that was processed anywhere in the network of servers that provides the shared execution of the process software. The summed measurements of use units are periodically multiplied by unit costs, and the resulting total process software application service costs are alternatively sent to the customer or indicated on a web site accessed by the customer, which then remits payment to the service provider.

In another embodiment, the service provider requests payment directly from a customer account at a banking or financial institution.

In yet another embodiment, if the service provider is also a customer of the customer that uses the process software application, the payment owed to the service provider is reconciled to the payment owed by the service provider to minimize the transfer of payments.

While there have been shown and described what are at present considered the preferred embodiments of the invention, it will be obvious to those skilled in the art that various changes and modification may be made therein without departing from the scope of the invention as defined by the appended claims.

1. A method of implementing a software product for a client, comprising the steps of:
acquiring a software product having a plurality of views and objects;
planning a configuration of said software product for a client;
automatically determining which of said plurality of views and objects are impacted by said configuration;
modifying the impacted views and objects in accordance with the planned configuration;
automatically checking the modified views and objects;
creating reports populated with data from the modified views and objects, for delivery to said client; and
automatically documenting the planned configuration.

2. The method of claim 1, wherein said objects are applets, business components, or fields.

3. The method of claim 1, further comprising displaying said which of said plurality of views and objects, in a spreadsheet.

4. The method of claim 3, wherein said spreadsheet is populated with pre-defined queries.

5. The method of claim 3, wherein said objects are modified by entering modifications into said spreadsheet.

6. The method of claim 5, wherein said spreadsheet having the modified objects is stored into a database of tables.

7. The method of claim 1, wherein said software product has a repository and data tables.

8. The method of claim 7, wherein said data tables are static scope tables.

9. The method of claim 7, further comprising copying a subset of said software product and repository, comprising said impacted objects and views, into a database of tables.

10. The method of claim 7, wherein said determining is performed by automatically examining data in said repository and data tables.

11. The method of claim 1, wherein said automatically checking includes providing review warnings.

12. The method of claim 1, wherein said automatically documenting includes creating baseline design documents.

13. The method of claim 12, wherein said design documents are word processor documents.

14. A method of delivering a services offering, comprising the steps of:
acquiring a software product having a plurality of views and objects;
planning a configuration of said software product for a client;
automatically determining which of said plurality of views and objects are impacted by said configuration;
modifying the impacted views and objects in accordance with the planned configuration;
automatically checking the modified views and objects;
creating reports populated with data from the modified views and objects, for delivery to said client;
automatically documenting the planned configuration; and
delivering the configured software product to a client.

15. The method of claim 14, wherein said software product has a repository and data tables.

16. The method of claim 15, wherein said determining is performed by automatically examining data in said repository and data tables.

17. The method of claim 16, further comprising displaying said which of said plurality of views and objects, in a spreadsheet.

18. The method of claim 17, wherein said objects are modified by entering modifications into said spreadsheet.

19. The method of claim 1, including deploying process software for implementing a software product, said deployment comprising:
installing said process software on at least one server;
identifying server addresses for users accessing said process software on said at least one server;
installing a proxy server if needed;
sending said process software to said at least one server via a file transfer protocol, or sending a transaction to said at least one server containing said process software and receiving and copying said process software to said at least one server's file system;
accessing said process software on a user's client computer file system; and
executing said process software by said users.

20. The method of claim 19, wherein said step of installing said process software further comprises:
determining if programs will reside on said at least one server when said process software is executed;
identifying said at least one server that will execute said process software; and
transferring said process software to said at least one server's storage.

21. The method of claim 19, wherein said step of accessing said process software includes having said at least one server automatically copying said process software to each client computer, running an installation program at each client computer, and executing said installation program on said client computer.

22. The method of claim 19, wherein sending said process software to said users via email further comprises identifying said users and addresses of said client computers.

23. The method of claim 19, wherein said step of executing said process software by said users includes sending said process software to directories on said client computers.

24. The method of claim 19, wherein said step of accessing said process software comprises sending said process software to users via email.

25. The method of claim 1, including integrating process software for implementing a software product for a client, said integration comprising:
determining if said process software will execute on at least one server;
identifying said at least one server address, including checking said at least one server for operating systems, applications network operating systems, or version numbers for validation with said process software, and identifying any missing software applications that are required for integration;
updating said operating systems, said applications, or said network operating systems that are not validated for said process software, and providing any of said missing software applications required for said integration;
identifying client addresses and checking said client's computers for operating systems, applications, network operating systems, or version numbers for validation with said process software, and identifying any missing software applications that are required for integration;
updating said client's computers with said operating systems, said applications, or said network operating systems that are not validated for said process software, and providing any of said missing software applications required for said integration; and
installing said process software on said client's computers and said at least one server.

26. The method of claim 1 including on demand sharing of process software for implementing a software product for a client, said on demand sharing comprising:
creating a transaction containing unique customer identification, requested service type, and service parameters;
sending said transaction to at least one main server;
querying said server's central processing unit capacity for adequate processing of said transaction; and
allocating additional central processing unit capacity when additional capacity is needed to process said transaction, and adding said additional central processing unit capacity to said server, or checking environmental capacity for processing said transaction, including network bandwidth, processor memory, or storage, and allocating said environmental capacity as required.

27. The method of claim 26, further comprising recording usage measurements including network bandwidth, processor memory, storage, or said central processing unit cycles.

28. The method of claim 27, further comprising summing said usage measurements, acquiring a multiplicative value of said usage measurements and unit costs, and recording said multiplicative value as an on demand charge to a requesting customer.

29. The method of claim 28, further comprising posting said on demand charge on a web site if requested by said requesting customer, or sending said demand charge via email to said requesting customer's email address.

30. The method of claim 28, further comprising charging said on demand charge to said requesting customer's account if an account exists and said requesting customer selects a charge account payment method.

31. The method of claim 1, including deploying, accessing, and executing process software for updating access control for referenced databases in documents sent via email by an originator to addresses through a virtual private network, said method further comprising:
determining if said virtual private network is required;
checking for remote access of said virtual private network;
if said remote access does not exist, identifying a third party provider to provide secure, encrypted connections between a private network and remote users, identifying said remote users, and setting up a network access server for downloading and installing desktop client software for remotely accessing said virtual private network;
accessing said process software;
transporting said process software to said remote user's desktop; and
executing said process software on said remote user's desktop.

32. The method of claim 31, further comprising:
determining if said virtual private network is available for site-to-site access, or installing equipment required to establish said site-to-site virtual private network, and installing large scale encryption into said virtual private network; and
accessing said process software on said site-to-site configuration.

33. The method of claim 31, wherein said step of accessing said process software further comprises dialing into said network access server or attaching directly via a cable or DSL modem into said network access server.
